(19) United States
(12) Patent Application Publication
(10) Pub. No.: US 2014/0328324 A1
(43) Pub. Date: Nov. 6, 2014

(54) RADIO BASE STATION AND METHOD OF CONTROLLING TRANSITION BETWEEN RADIO SYSTEMS

(71) Applicant: NTT DOCOMO, INC., Tokyo (JP)

(72) Inventors: Kunihiko Teshima, Chiyoda-ku, Tokyo (JP); Masafumi Masuda, Chiyoda-ku, Tokyo (JP); Yuji Akai, Chiyoda-ku, Tokyo (JP); Yasuhiro Kanetaka, Chiyoda-ku, Tokyo (JP)

(21) Appl. No.: 14/361,712

(22) PCT Filed: Nov. 29, 2012
(86) PCT No.: PCT/JP2012/080989

§ 371 Date: May 30, 2014

(30) Foreign Application Priority Data
Dec. 9, 2011 (JP) 2011-270714

(51) Int. Cl. H04W 36/00

(52) U.S. Cl. CPC H04W 36/0094; H04W 88/10
USPC 370/331

(57) ABSTRACT

A radio base station capable of communication in a first radio system and a second radio system includes a measurement unit arranged to measure a radio wave transmitted from a neighbor radio base station in the first radio system; a configuration unit arranged to configure a measurement criterion whether measurement of a radio wave is needed upon transition from the second radio system to the first radio system based on a measurement result by the measurement unit; and a determination unit arranged to determine whether to make transition accompanied by measurement of the radio wave based on the measurement criterion configured by the configuration unit, when transition from the second radio system to the first radio system is requested.

### TECHNICAL FIELD

The present invention relates to a radio base station and a method of controlling transition between radio systems.

### BACKGROUND ART

A mobile communication system called a “W-CDMA (Wideband-Code Division Multiple Access) system” has been recently proposed and standardized by 3GPP (The 3rd Generation Partnership Project). In addition, a mobile communication system called an “LTE (Long Term Evolution) system” has been proposed and standardized, which aims to enhance a W-CDMA system.

Both of a W-CDMA system and an LTE system belong to a cellular-based mobile communication system. Specifically, an area called a “cell”, within which cellular-based control is carried out, is formed by a radio wave transmitted from a radio base station.

In addition to a radio base station to cover a wide outdoor area, a small radio base station (hereinafter called a “femto-cell base station) has been deployed in order to mainly cover a narrow area such as an indoor area. As used herein, a cell formed by an outdoor radio base station is called a “macro cell” and a cell formed by a femto-cell base station is called a “femto cell”. A femto-cell base station measures a reception level of a macro cell and determines transmission power based on the measurement result. A femto-cell base station is deployed in a house, a small office, or the like to provide a small coverage area, to utilize a low-cost IP (Internet Protocol) line for a home user for connecting to a radio control station, and so on. By using one or more femto cells to form a private area for a particular user, user-specific services are under consideration to provide a different billing plan for the particular user in the femto cells, to provide additional functions limited to the femto cells, and so on.

In addition to a femto-cell base station which supports either a W-CDMA system or an LTE system, a femto-cell base station which supports both of these systems (hereinafter called a “dual femto-cell base station”) is under consideration. When a mobile station which supports both a W-CDMA system and an LTE system is situated within a cell formed by the dual femto-cell base station, the mobile station can dynamically use both of these systems. For example, a circuit switching service for voice communication is not provided in an LTE system. In this case, when the mobile station situated in the LTE system performs voice communication, the mobile station needs to transition to a W-CDMA system. This transition is called “CSFB” (Circuit Switched Fallback) (see Itsuma Tanaka, et. al., “CS Fallback Function for Combined LTE and 3G Circuit Switched Services”, NTT DOCOMO Technical Journal, Vol. 17, No. 3, October, 2009).

### DISCLOSURE OF INVENTION

### Problem(S) to be Solved by the Invention

In one CSFB scheme, CSFB can be performed without measuring quality of a cell (W-CDMA cell) in a W-CDMA system. This CSFB scheme is called “CSFB according to Blind HO” (Blind Handover). On the other hand, in another CSFB scheme, CSFB can be performed after measuring quality of a W-CDMA cell. This CSFB scheme is called “CSFB accompanied by a Measurement Procedure”. It is expected that which of these schemes is used for CSFB will be uniformly specified in each cell by station data (configuration data stored in a station).

If the station data uniformly specifies which of CSFB according to Blind HO and CSFB accompanied by a Measurement Procedure is used for CSFB in each cell, all mobile stations situated in the cell perform either CSFB according to Blind HO or CSFB accompanied by a Measurement Procedure based on the station data configured in a radio base station associated with the cell. In addition, if CSFB according to Blind HO is specified, all mobile stations situated in the cell make transition to the cell specified by the station data configured in the radio base station associated with the cell.

Since voice communication typically requires little delay, the use of CSFB according to Blind HO is contemplated.

CSFB according to Blind HO is superior in terms of delay, because there is no need to measure quality of a W-CDMA cell. CSFB according to Blind HO is based on the precondition that there are W-CDMA cells in the areas covered by LTE cells. For a dual femto-cell base station, on the other hand, the areas covered by W-CDMA cells are not necessarily identical with the areas covered by LTE cells, because transmission power is determined based on a reception level of a macro cell. For example, when a reception level of a W-CDMA macro cell in the neighborhood of the dual femto-cell base station is better, transmission power of the dual femto-cell base station for the W-CDMA system becomes lower and accordingly, a W-CDMA cell formed by the dual femto-cell base station becomes smaller. As a result, when a mobile station situated near the cell edge of the LTE system performs CSFB according to Blind HO, CSFB may end in failure because there is no W-CDMA cell.

As mentioned above, the CSFB scheme can be configured in each cell by station data. However, it is not efficient from the viewpoint of operational costs and labor costs to measure, for each femto-cell base station, a radio wave in a macro cell to configure the CSFB scheme, because the number of femto-cell base stations is much larger than the number of macro-cell base stations.

It is a general object of the present invention to provide a radio base station and a method of controlling transition between radio systems to autonomously determine whether measurement of a radio wave is needed upon transition between radio systems such as upon CSFB.

### Means for Solving the Problem(S)

In order to achieve the object of the present invention, there is provided a radio base station capable of communication in a first radio system and a second radio system, including:

a measurement unit arranged to measure a radio wave transmitted from a neighbor radio base station in the first radio system;

a configuration unit arranged to configure a measurement criterion whether measurement of a radio wave is needed upon transition from the second radio system to the first radio system based on a measurement result by the measurement unit; and

a determination unit arranged to determine whether to make transition accompanied by measurement of the radio wave based on the measurement criterion configured by the configuration unit, when transition from the second radio system to the first radio system is requested.

In addition, there is provided a method of controlling transition between radio systems in a radio base station capable of communication in a first radio system and a second radio system, including the steps of:

measuring a radio wave transmitted from a neighbor radio base station in the first radio system;

configuring a measurement criterion whether measurement of a radio wave is needed upon transition from the second radio system to the first radio system based on a measurement result by the measurement unit; and

determining whether to make transition accompanied by measurement of the radio wave based on the measurement criterion configured in the configuring step, when transition from the second radio system to the first radio system is requested.

### Advantageous Effect of the Invention

According to the present invention, a radio base station can autonomously determine whether measurement of a radio wave is needed upon transition between radio systems.

### BRIEF DESCRIPTION OF THE DRAWINGS

FIG. 1 shows an exemplary configuration of a W-CDMA system in accordance with an embodiment of the present invention.

FIG. 2 shows an exemplary configuration of an LTE system in accordance with an embodiment of the present invention.

FIG. 3 shows a sequence diagram of a CSFB procedure.

FIG. 4 shows sizes of a W-CDMA cell and an LTE cell formed by a dual femto-cell base station.

FIG. 5 shows a functional block diagram of a radio base station in accordance with an embodiment of the present invention.

FIG. 6 shows a flowchart of a method of configuring a measurement criterion upon CSFB in accordance with an embodiment of the present invention.

FIG. 7 shows a sequence diagram of a method of performing CSFB in accordance with an embodiment of the present invention.

FIG. 8 shows a flowchart of a method of configuring a measurement criterion upon CSFB in accordance with an embodiment of the present invention (in the case of periodic configuration).

### DETAILED DESCRIPTION OF THE PREFERRED EMBODIMENTS

In an embodiment of the present invention, a radio base station capable of communication in a plurality of radio systems is used. For example, the radio base station may be a dual femto-cell base station which supports both a W-CDMA system and an LTE system.

A mobile station in communication with the radio base station may make transition between radio systems. For example, the mobile station situated in the LTE system may make transition to the W-CDMA system for voice communication. In the embodiment of the present invention, a measurement criterion is used to determine whether to make transition accompanied by measurement of a radio wave or transition without measurement of a radio wave upon the transition between radio systems.

The radio base station measures a radio wave transmitted from a neighbor radio base station in at least one of the radio systems. For example, the dual femto-cell base station measures a radio wave in a neighbor W-CDMA macro cell. The radio base station configures the measurement criterion whether measurement of a radio wave is needed upon transition between radio systems based on the measurement result of the radio wave. For example, when the measurement result of the neighbor W-CDMA macro cell is above a predetermined threshold, the measurement criterion is configured such that measurement of a radio wave is needed upon transition from the LTE system to the W-CDMA system.

When transition between radio systems is requested, the radio base station determines whether to make transition accompanied by measurement of the radio wave based on the configured measurement criterion. For example, when a measurement criterion that measurement of the radio wave is needed is configured, the radio base station determines that transition accompanied by measurement of the radio wave is to be made upon transition between radio systems.

An embodiment of the present invention is described below with reference to the accompanying drawings.

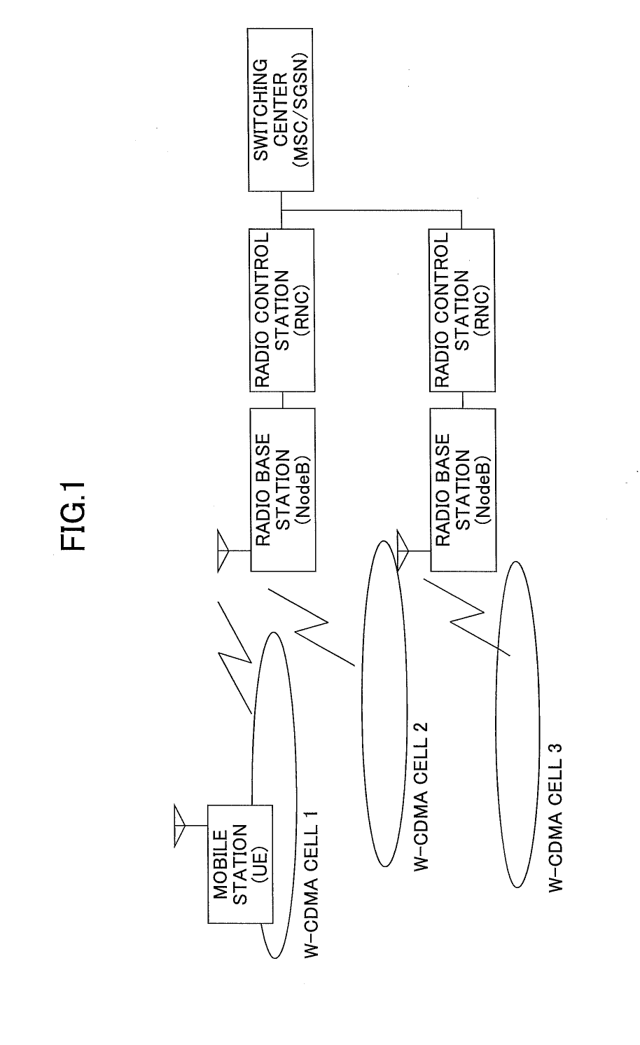

FIG. 1 shows an exemplary configuration of a W-CDMA system in accordance with an embodiment of the present invention. The W-CDMA system includes a mobile station (UE: User Equipment), a radio base station (NodeB), a radio control station (RNC: Radio Network Controller), and a switching center (MSC/SGSN: Mobile Switching Center/Serving GPRS Support Node). In the W-CDMA system, a circuit switching (CS) service and a packet switching (PS) service are provided to the mobile station. In the W-CDMA system, cellular-based mobile communication system is configured. More specifically, cells (for example, a W-CDMA cell 1, a W-CDMA cell 2, and a W-CDMA cell 3 shown in FIG. 1) are formed by radio waves transmitted from the radio base stations. The radio base station may be a radio base station which forms a macro cell or a femto-cell base station which forms a femto cell.

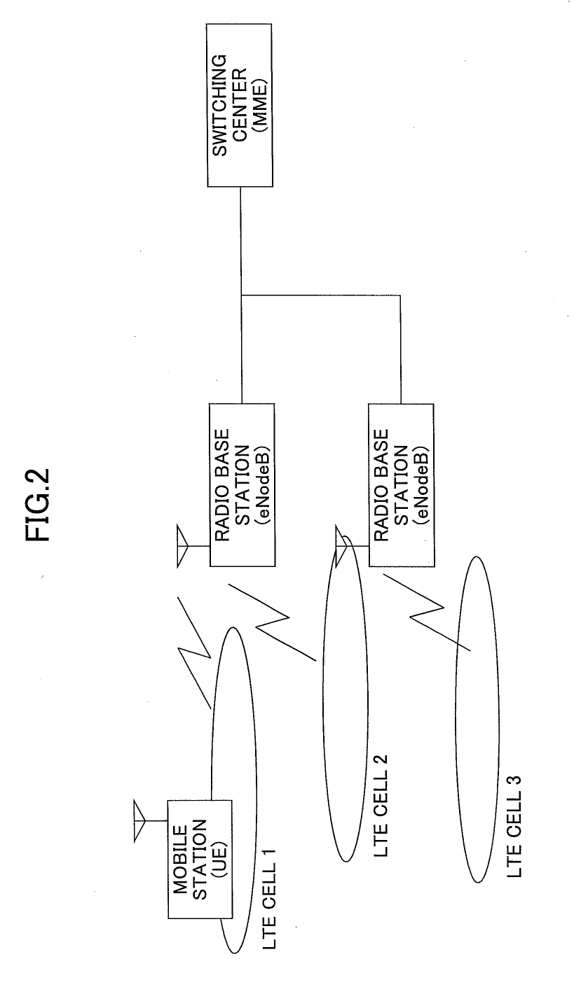

FIG. 2 shows an exemplary configuration of an LTE system in accordance with to an embodiment of the present invention. The LTE system includes a mobile station (UE), a radio base station (eNodeB), and a switching center (MME: Mobility Management Entity). The functions provided by the radio control station in the W-CDMA system are included in the radio base station or the switching center in the LTE system. In the LTE system, a packet switching service is provided to the mobile station. In the LTE system, cellular-based mobile communication system is also configured. More specifically, cells (for example, an LTE cell 1, an LTE cell 2, and an LTE cell 3 shown in FIG. 2) are formed by radio waves transmitted from the radio base stations. The radio base station may be a radio base station which forms a macro cell or a femto-cell base station which forms a femto cell.

It should be noted that an embodiment of the present invention can be applied to both the case where a radio control station is provided separately from a radio base station and a switching center as shown in FIG. 1 and the case where no radio control station is provided as shown in FIG. 2.

For example, when a circuit switching service such as a voice communication service is not provided in an LTE system, a mobile station situated in the LTE system needs to transition to a W-CDMA system for voice communication. In other words, CSFB is needed.

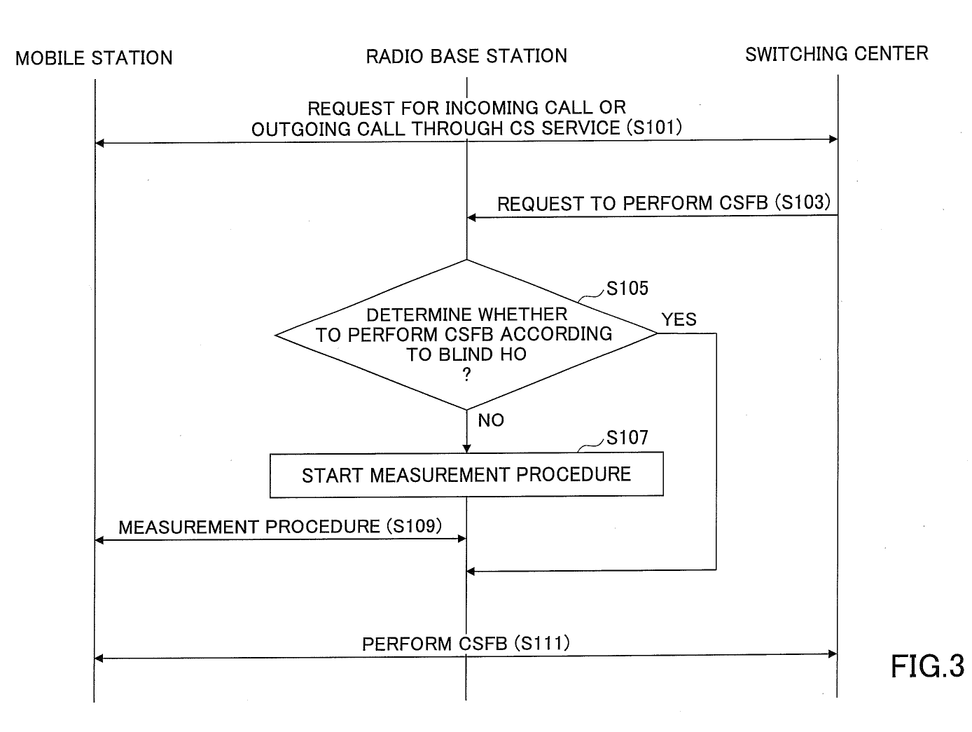

FIG. 3 shows a sequence diagram of a CSFB procedure. When a request for originating or receiving a call of a CS service is made to a mobile station situated in an LTE system (step S101), a radio link is established between the mobile station and a switching center and authentication and security are also established if the mobile station is in the idle state. Then, the switching center requests a radio base station to perform CSFB (step S103).

Station data in the radio base station includes whether to perform CSFB without measuring quality of a W-CDMA cell (to perform CSFB according to Blind HO) or to perform CSFB after measuring quality of a W-CDMA cell (to perform CSFB accompanied by a Measurement Procedure). The radio base station obtains the station data and determines whether to perform CSFB according to Blind HO (step S105).

When CSFB according to Blind HO is not to be performed, in other words, when CSFB according to a Measurement Procedure is to be performed (step S105: NO), the radio base station starts a Measurement Procedure (step S107). Then a Measurement Procedure is performed between the mobile station and the radio base station (step S109) and quality of the W-CDMA cell is measured. Then, CSFB is performed and the mobile station makes transition to the W-CDMA system (step S111).

When CSFB according to Blind HO is to be performed (step S105: YES), CSFB is performed without a Measurement Procedure and the mobile station makes transition to the W-CDMA system (step S111).

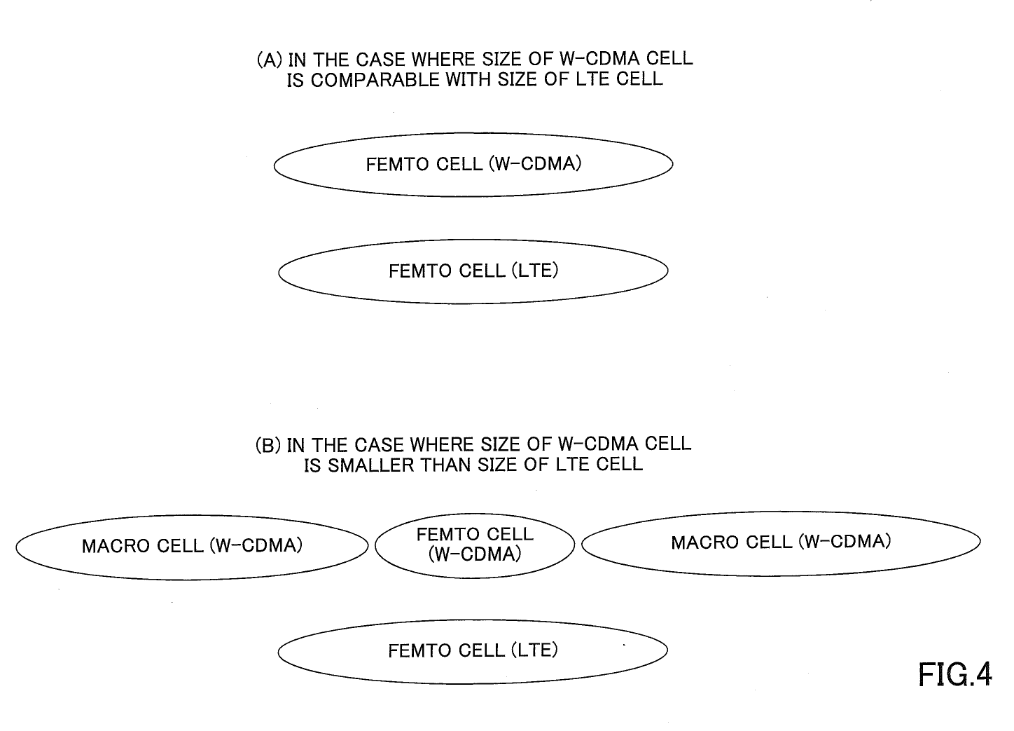

As understood from FIG. 3, CSFB according to Blind HO is suitable for voice communication which requires little delay, because there is no need to measure quality of a W-CDMA cell (steps S107 and S109). However, when there is no W-CDMA cell in the area covered by an LTE cell, CSFB according to Blind HO may end in failure. This scenario is described below with reference to FIG. 4.

FIG. 4 shows sizes of a W-CDMA cell and an LTE cell formed by a dual femto-cell base station. The dual femto-cell base station determines transmission power based on a reception level of a macro cell in order to reduce effects on a radio wave in the macro cell. For example, when there is no neighbor W-CDMA macro cell or LTE macro cell or when reception levels of a neighbor W-CDMA macro cell and an LTE macro cell are low, the size of the W-CDMA cell formed by the dual femto-cell base station is almost the same as that of the LTE cell formed by the dual femto-cell base station, as shown in FIG. 4(A). Since the precondition that there are W-CDMA cells in the areas covered by LTE cells is satisfied, there is a high probability that CSFB according to Blind HO will succeed. For example, in the case of FIG. 4(A), there is a high probability that CSFB according to Blind HO from the LTE femto cell to the W-CDMA femto cell will succeed.

On the other hand, when there is no neighbor LTE macro cell or when a reception level of a neighbor LTE macro cell is low while a reception level of a neighbor W-CDMA macro cell is high, the size of the W-CDMA cell formed by the dual femto-cell base station is smaller than that of the LTE cell formed by the dual femto-cell base station, as shown in FIG. 4(B). When a mobile station is situated near the cell edge of the LTE system, CSFB according to Blind HO may end in failure. For example, in the case of FIG. 4(B), CSFB according to Blind HO from the LTE femto cell to the W-CDMA femto cell may end in failure.

While a dual femto-cell is taken as an example in FIG. 4, CSFB according to Blind HO may end in failure when there is no W-CDMA cell in the area covered by an LTE cell, regardless of whether a dual femto-cell is used.

In an embodiment of the present invention, a radio base station measures a radio wave in a neighbor W-CDMA macro cell and configures a measurement criterion whether to perform CSFB accompanied by a Measurement Procedure or CSFB according to Blind HO. A configuration and an operation of a radio base station are described in detail below.

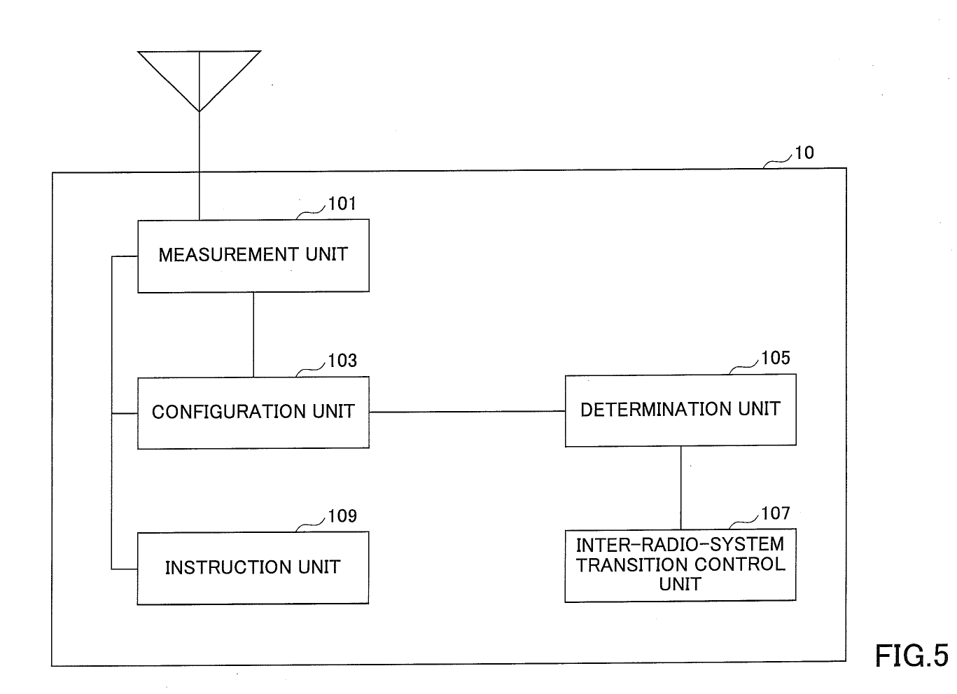

FIG. 5 shows a functional block diagram of a radio base station 10 in accordance with an embodiment of the present invention. The radio base station 10 is capable of communication in a plurality of radio systems. For example, the radio base station 10 may be a dual femto-cell base station which supports both a W-CDMA system and an LTE system. The radio base station 10 includes a measurement unit 101, a configuration unit 103, a determination unit 105, and an inter-radio-system transition control unit 107. The radio base station 10 may further include an instruction unit 109.

The measurement unit 101 measures a radio wave transmitted from a neighbor radio base station in at least one of the radio systems. The measurement unit 101 may receive a radio wave transmitted from a neighbor radio base station and measure radio field intensity or reception quality. For example, the measurement unit 101 measures radio field intensity or reception quality of a neighbor W-CDMA macro cell. The radio field intensity may be received power and the reception quality may be an SINR (signal-to-interference plus noise power ratio). The measurement unit 101 provides the measurement result to the configuration unit 103. The measurement unit 101 may also measure both radio field intensity or radio quality of a neighbor W-CDMA macro cell and radio field intensity or radio quality of a neighbor LTE macro cell in order to compare sizes between the W-CDMA macro cell and the LTE macro cell formed by the radio base station 10.

The configuration unit 103 configures a measurement criterion whether measurement of a radio wave is needed upon transition between radio systems. For example, when the measurement result of the neighbor W-CDMA macro cell is above a predetermined threshold, the measurement criterion that measurement of a radio wave is needed upon CSFB from the LTE system to the W-CDMA system is configured. On the other hand, when the measurement result of the neighbor W-CDMA macro cell is below the predetermined threshold, the measurement criterion that measurement of a radio wave is not needed upon CSFB from the LTE system to the W-CDMA system is configured. The predetermined threshold to be used to configure the measurement criterion is determined in advance as station data in the radio base station 10. The configured measurement criterion may be stored in a storage unit of the radio base station 10 as a measurement flag indicating the necessity for measurement. When both the radio wave in the neighbor W-CDMA macro cell and the radio wave in the neighbor LTE macro cell are measured, the configuration unit 103 may compare the measurement results between the neighbor W-CDMA macro cell and the neighbor LTE macro cell and configure whether measurement of a radio wave is needed upon CSFB from the LTE system to the W-CDMA system.

The determination unit 105 determines whether to make transition accompanied by measurement of a radio wave based on the configured measurement criterion, when transition between radio systems is requested. For example, when the measurement criterion that measurement of a radio wave is needed is configured, the determination unit 105 determines that CSFB accompanied by a Measurement Procedure is to be performed upon CSFB. On the other hand, when the measurement criterion that measurement of a radio wave is not needed is configured, the determination unit 105 determines that CSFB according to Blind HO is to be performed upon CSFB.

The inter-radio-system transition control unit 107 performs CSFB by making transition between radio systems in the mobile station and the radio base station 10 as well as in the radio base station 10 and the switching center.

The instruction unit 109 causes the measurement unit 101 to periodically measure the radio wave and causes the configuration unit 103 to periodically configure the measurement criterion in order to periodically reconfigure the measurement criterion. More specifically, the instruction unit 109 includes a timer to periodically reconfigure the measurement criterion. When the timer expires, the instruction unit 109 causes the measurement unit 101 to periodically measure the radio wave and causes the configuration unit 103 to periodically configure the measurement criterion. The instruction unit 109 may be included in the measurement unit 101 and the configuration unit 103.

Next, a method of controlling transition between radio systems in accordance with an embodiment of the present invention is described below. This method is broadly divided into a method of configuring a measurement criterion and a method of performing CSFB using the configured measurement criterion.

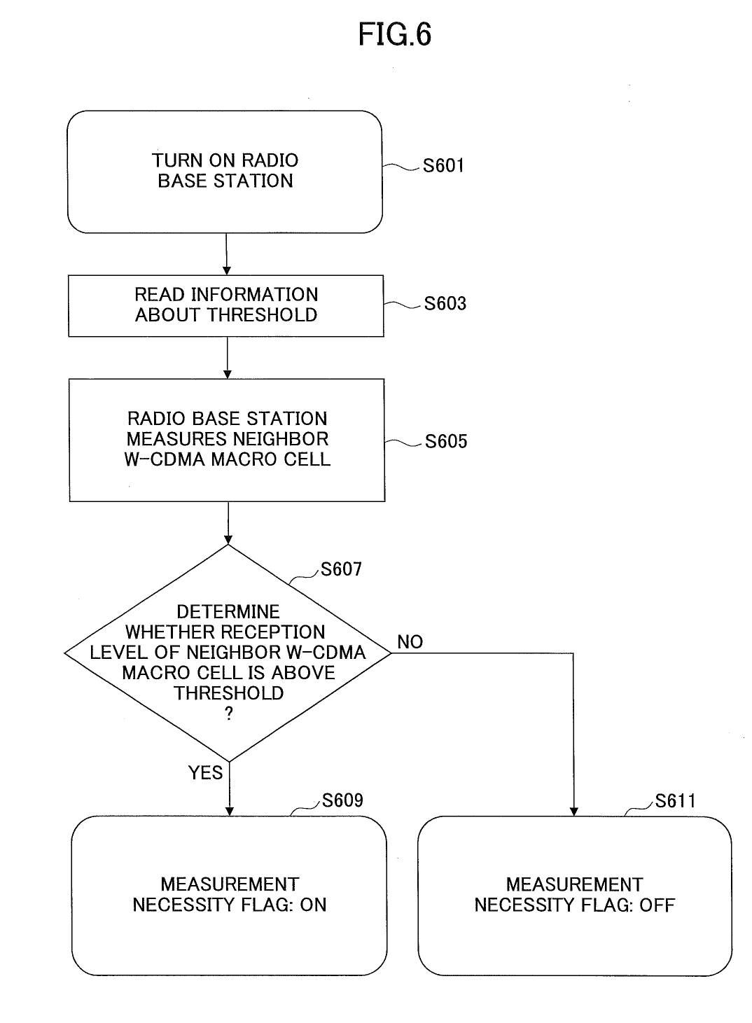

FIG. 6 shows a flowchart of a method of configuring a measurement criterion upon CSFB in accordance with an embodiment of the present invention. For example, this method is performed upon power-up of a radio base station such as a dual femto-cell base station.

Upon power-up of a radio base station such as a dual femto-cell base station (step S601), the radio base station reads a predetermined threshold to be used to configure a measurement criterion by referring to station data (step S603). Then, the radio base station measures a radio wave in a neighbor W-CDMA macro cell (step S605). When a reception level or reception quality is above the predetermined threshold (step S607: YES), the radio base station sets a measurement flag as the measurement criterion to ON (step S609). When a reception level or reception quality is not above the predetermined threshold (step S607: NO), the radio base station sets the measurement flag to OFF (step S611).

In step S605, both the radio wave in the neighbor W-CDMA macro cell and the radio wave of the neighbor LTE macro cell may be measured. In step S607, the measurement results between the neighbor W-CDMA macro cell and the neighbor LTE macro cell may be compared.

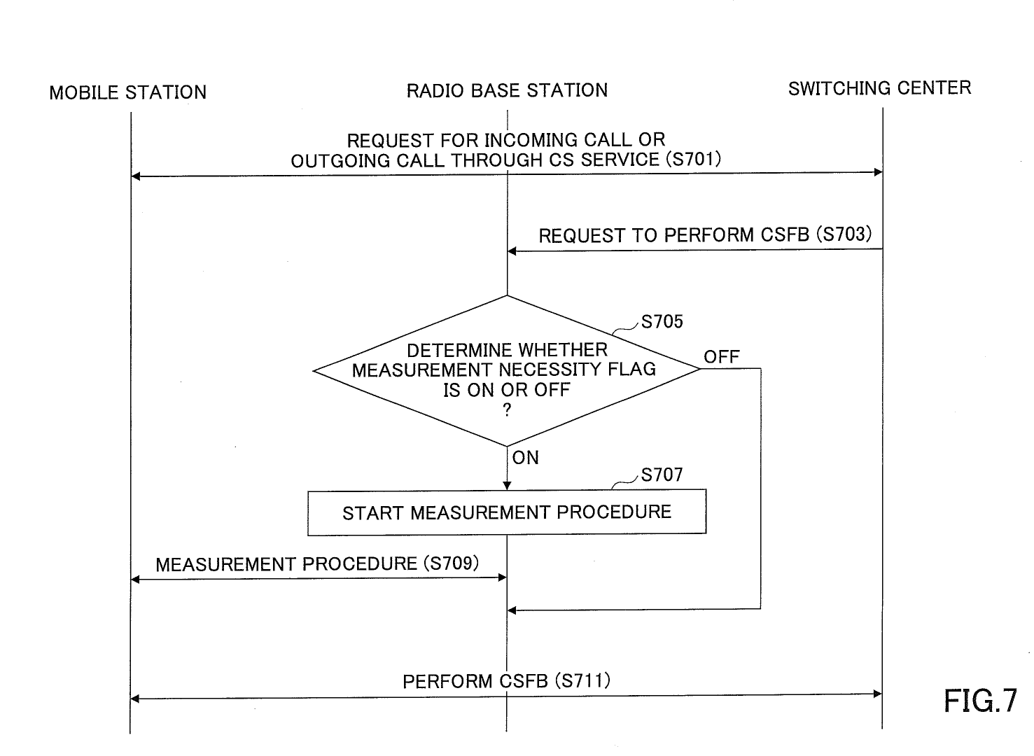

FIG. 7 shows a sequence diagram of a method of performing CSFB in accordance with an embodiment of the present invention. The method of performing CSFB is performed every time CSFB is requested.

When a request for originating or receiving a call of a CS service is made to a mobile station situated in an LTE system (step S701), a radio link is established between the mobile station and a switching center and authentication and security are also established if the mobile station is in the idle state. Then, the switching center requests a radio base station to perform CSFB (step S703).

The radio base station determines whether the measurement flag configured according to the method shown in FIG. 6 is ON or OFF (step S705). When the measurement flag is ON (step S705: ON), the radio base station starts a Measurement Procedure (step S707). Then, the Measurement Procedure is performed between the mobile station and the radio base station (step S709) and quality of a W-CDMA cell is measured. Then, CSFB is performed and the mobile station makes transition to the W-CDMA system (step S711).

When the measurement flag is OFF (step S705: OFF), CSFB is performed without a Measurement Procedure and the mobile station makes transition to the W-CDMA system (step S711).

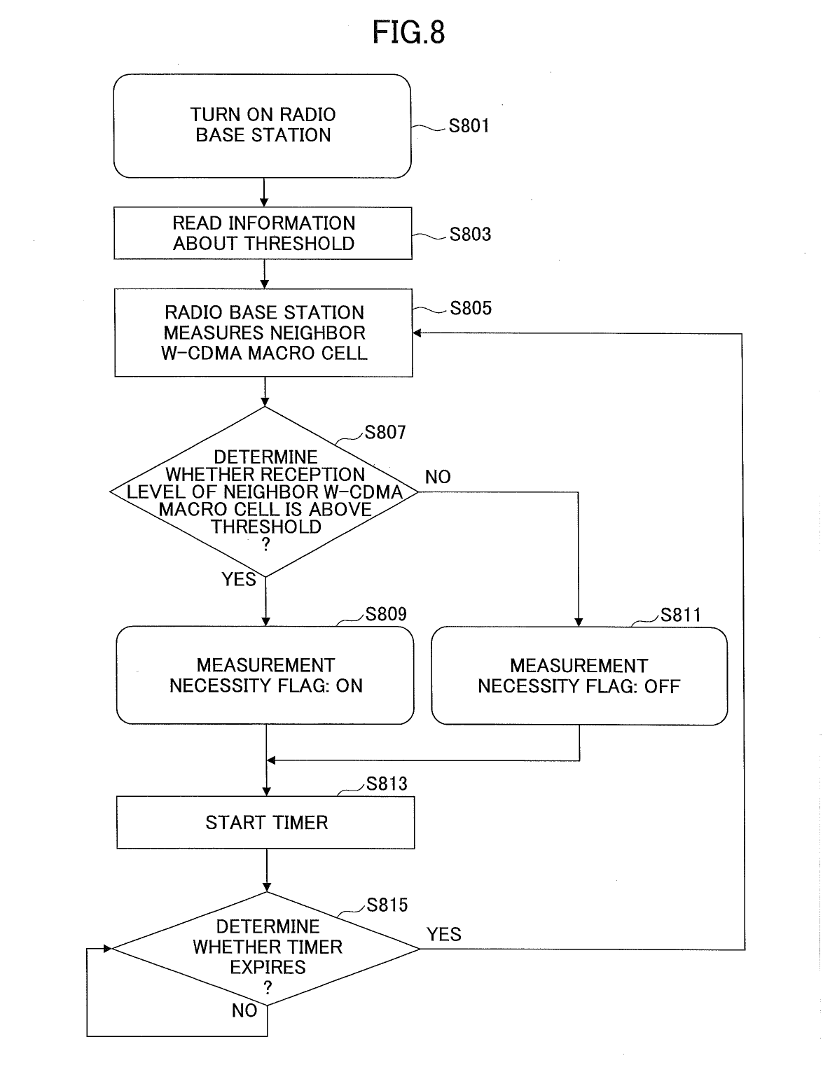

FIG. 8 shows a flowchart of a method of configuring a measurement criterion upon CSFB in accordance with an embodiment of the present invention in the case where the measurement criterion is periodically reconfigured. Steps S801-S811 in FIG. 8 are the same as steps S601-S611 in FIG. 6. In FIG. 8, after the measurement flag is configured in step S809 or S811, the radio base station starts a timer to periodically configure the measurement flag (step S813). When the timer has been already started, the radio base station restarts the timer. In other words, the timer value is reset to an initial value and the timer is started. When the timer expires (step S815), the radio base station measures the radio wave in the neighbor macro cell again (step S805) and configures the measurement flag (steps S807-S811).

<Effects of Embodiments>

According to an embodiment of the present invention, failure of CSFB which is transition between radio systems can be reduced by configuring a measurement criterion whether measurement of a radio wave is needed upon transition between radio systems based on the measurement result of the radio wave.

In addition, operational costs and labor costs associated with configurations of a large number of dual femto-cell base stations can be reduced by applying an embodiment of the present invention to the dual femto-cell base stations.

Furthermore, by using a timer to reconfigure the measurement criterion, a change in the environment of macro cells can be adapted to.

For convenience of explanation, the apparatus according to the embodiments of the present invention has been described with reference to functional block diagrams, but the apparatus may be implemented in hardware, software, or combinations thereof. In addition, two or more functional elements may be combined as appropriate.

For convenience of explanation, the method according to the embodiments of the present invention has been described with reference to flowcharts, but the method may be carried out in a different order from the order shown in the embodiments.

While the embodiments of the present invention are described above, the present invention is not limited to the these embodiments, and variations, modifications, alterations, and substitutions can be made by those skilled in the art without deviating from the spirit of the present invention.

The present international application is based on and claims the benefit of priority of Japanese Patent Application No. 2011-270714 filed on Dec. 9, 2011, the entire contents of which are hereby incorporated by reference.

### DESCRIPTION OF NOTATIONS

10 radio base station
101 measurement unit
103 configuration unit
105 determination unit
107 inter-radio-system transition control unit
109 instruction unit

1. A radio base station capable of communication in a first radio system and a second radio system, comprising:
a measurement unit arranged to measure a radio wave transmitted from a neighbor radio base station in the first radio system;
a configuration unit arranged to configure a measurement criterion whether measurement of a radio wave is needed upon transition from the second radio system to the first radio system based on a measurement result by the measurement unit; and
a determination unit arranged to determine whether to make transition accompanied by measurement of the radio wave based on the measurement criterion configured by the configuration unit, when transition from the second radio system to the first radio system is requested.

2. The radio base station as claimed in claim 1,
wherein the configuration unit configures the measurement criterion so that measurement of the radio wave is needed upon transition from the second radio system to the first radio system, when the measurement result by the measurement unit is above a predetermined threshold.

3. The radio base station as claimed in claim 1, further comprising:
an instruction unit arranged to cause the measurement unit to periodically measure the radio wave and to cause the configuration unit to periodically configure the measurement criterion.

4. The radio base station as claimed in claim 1,
wherein the first radio system is a system which provides a circuit switching service and a packet switching service and the second radio system is a system which provides a packet switching service.

5. A method of controlling transition between radio systems in a radio base station capable of communication in a first radio system and a second radio system, comprising the steps of:
measuring a radio wave transmitted from a neighbor radio base station in the first radio system;
configuring a measurement criterion whether measurement of a radio wave is needed upon transition from the second radio system to the first radio system based on a measurement result by the measurement unit; and
determining whether to make transition accompanied by measurement of the radio wave based on the measurement criterion configured in the configuring step, when transition from the second radio system to the first radio system is requested.
